(19) United States
(12) Patent Application Publication
(10) Pub. No.: US 2018/0039440 A1
(43) Pub. Date: Feb. 8, 2018

(54) NON-TRANSITORY COMPUTER-READABLE RECORDING MEDIUM, BOUNDARY VALUE SPECIFYING METHOD, AND BOUNDARY VALUE SPECIFYING APPARATUS

(71) Applicant: FUJITSU LIMITED, Kawasaki-shi (JP)

(72) Inventor: Yasuhiko Kanemasa, Kawasaki (JP)

(73) Assignee: FUJITSU LIMITED, Kawasaki-shi (JP)

(21) Appl. No.: 15/626,224

(22) Filed: Jun. 19, 2017

(30) Foreign Application Priority Data
Aug. 3, 2016 (JP) 2016-152485

(51) Int. Cl. G06F 3/06

(52) U.S. Cl. CPC G06F 3/0629; G06F 3/0611; G06F 3/0653; G06F 3/0673

(57) ABSTRACT

A process includes collecting information relating to a response time to a service request to an information processing system and information relating to a used amount of a resource in the information processing system at specified time intervals, the used amount of the resource being used for the service request, fitting a prescribed distribution to a histogram of a response time in each of sections for a pair of the response time and the used amount of the resource, and calculating a degree of fitting of the histogram and the prescribed distribution in each of the sections, each of the sections being obtained by dividing the used amount of the resource at prescribed intervals, and specifying a boundary value that defines a threshold of the used amount of the resource in accordance with a change in the degree of fitting.

### CROSS-REFERENCE TO RELATED APPLICATION

This application is based upon and claims the benefit of priority of the prior Japanese Patent Application No. 2016-152485, filed on Aug. 3, 2016, the entire contents of which are incorporated herein by reference.

### FIELD

The embodiments discussed herein are related to a non-transitory computer-readable recoding medium, a boundary value specifying method, and a boundary value specifying apparatus.

### BACKGROUND

Cloud systems are utilized that each perform prescribed processing in accordance with a prescribed service request from a user terminal and that return a response to the user terminal. In such a system, prescribed processing is performed by using resources such as hardware resources or network resources. When a load on the resources increases, a response time to a request to the system increases, and the quality of a service provided by the system deteriorates.

Accordingly, information relating to resources (for example, a central processing unit (CPU) and the like) that are used for the system is collected, and a prescribed analysis is performed according to the collected information. As an example, a result of the analysis is presented to an administrator of the system, and the administrator takes countermeasures according to the result of the analysis.

As a related technology, a technology has been proposed for separating user layers in accordance with a qualitative or structural feature (see, for example, Patent Document 1). In addition, a technology has been proposed for fitting a normal distribution to an integration voltage from a histogram and obtaining the fitted normal distribution as a probability density distribution of the integration voltage (see, for example, Patent document 2).

[Patent Document 1] Japanese Laid-open Patent Publication No. 2010-123027

[Patent Document 2] International Publication Pamphlet No. WO 2013/080384

### SUMMARY

According to an aspect of the embodiments, a non-transitory computer-readable recoding medium having stored therein a boundary value specifying program that causes a computer to execute a process includes collecting information relating to a response time to a service request to an information processing system and information relating to a used amount of a resource in the information processing system at specified time intervals, the used amount of the resource being used for the service request, fitting a prescribed distribution to a histogram of a response time in each of sections for a pair of the response time and the used amount of the resource, and calculating a degree of fitting of the histogram and the prescribed distribution in each of the sections, each of the sections being obtained by dividing the used amount of the resource at prescribed intervals, and specifying a boundary value that defines a threshold of the used amount of the resource in accordance with a change in the degree of fitting.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the entire configuration of a system according to an embodiment.

FIG. 2 illustrates an example of an analysis server.

FIG. 3 is a scatter diagram illustrating an example of a relationship between a CPU utilization and a response time.

FIG. 4 illustrates an example of a three-dimensional histogram according to a CPU utilization and a response time.

FIG. 5 illustrates an example of a two-dimensional histogram of a CPU utilization in a prescribed section.

FIG. 6 illustrates an example in which the distribution diagram illustrated in FIG. 3 is divided into prescribed sections.

FIG. 7 illustrates an example (no. 1) in which an ex-Gaussian distribution is fitted to a histogram of a CPU utilization.

FIG. 8 illustrates an example (no. 2) in which an ex-Gaussian distribution is fitted to a histogram of a CPU utilization.

FIG. 9 illustrates a change in a parameter value (μ,σ,τ) in each section of a CPU utilization.

FIG. 10 is a diagram in which a parameter value (μ,σ,τ) is approximated to an orthogonal regression line in a three-dimensional space.

FIG. 11 is a scatter diagram illustrating a relationship between a CPU utilization and a response time after the detection of a boundary value.

FIG. 12 illustrates an example of an output result.

FIG. 13 is a flowchart (no. 1) illustrating an example of a flow of processing according to an embodiment.

FIG. 14 is a flowchart (no. 2) illustrating an example of a flow of processing according to an embodiment.

FIG. 15 is a flowchart (no. 3) illustrating an example of a flow of processing according to an embodiment.

FIG. 16 illustrates an example of a hardware configuration of a boundary value specifying apparatus.

### DESCRIPTION OF EMBODIMENTS

It is preferable that the quality of a service provided by a system do not deteriorate beyond a specified limit. Therefore, it is conceivable that whether the quality of the service provided by the system has deteriorated beyond the specified limit is determined according to a result of comparison between a used amount of a resource and a prescribed threshold. In this case, when the threshold to be compared with the used amount of the resource is not appropriately specified, it is difficult to appropriately determine whether the quality of the service has deteriorated beyond the specified limit.

### <Example of Entire Configuration of System According to Embodiment>

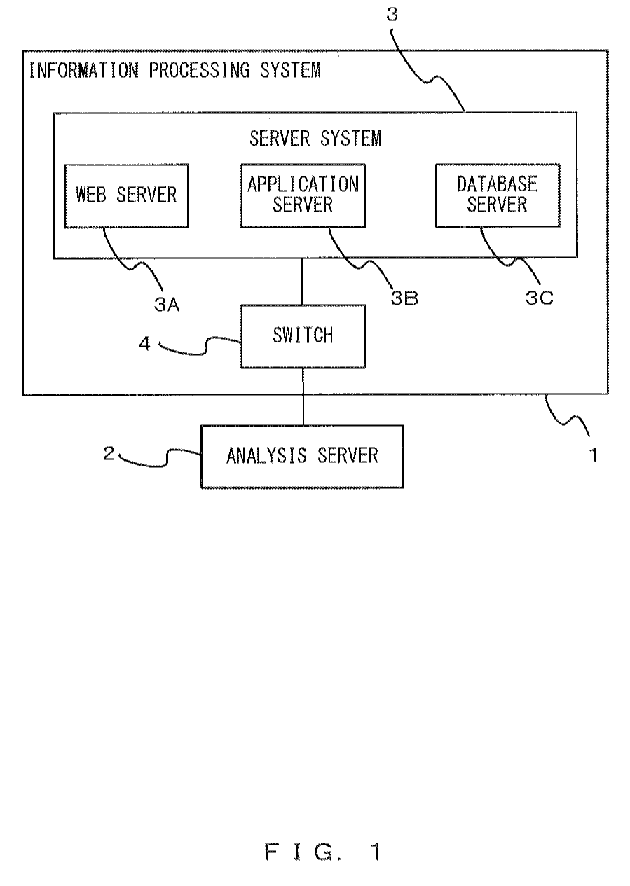

An embodiment is described below with reference to the drawings. FIG. 1 illustrates an example of the entire configuration of a system according to the embodiment. In the example of FIG. 1, an information processing system 1 is connected to an analysis server 2. As an example, the information processing system 1 is connected to the analysis server 2 via a network.

The information processing system 1 may be, for example, a cloud system. In this case, the information processing system 1 performs processing according to a service request (a request) that is transmitted from a prescribed client terminal, and returns a response to the client terminal.

The information processing system 1 includes a server system 3 and a switch 4. The server system 3 may be implemented by a technology in which a server, a storage, and the like are virtualized. In the embodiment, it is assumed that the server system 3 includes a three-layer system including a WEB server 3A, an application server 3B, and a database server 3C.

The switch 4 is a network switch. As an example, the switch 4 is connected to an external network (such as an Internet network), and the switch 4 relays the request above transmitted by the client terminal via the external network.

The analysis server 2 collects information relating to the information processing system 1 from the information processing system 1, and analyzes the information processing system 1 according to the collected information. The analysis server 2 is an example of a boundary value specifying apparatus or a computer. The analysis server 2 may be implemented by a portion of the information processing system 1.

The analysis server 2 collects, from the information processing system 1, information relating to a used amount of a resource such as a hardware resource or a network resource in the information processing system 1 that is used according to the request above (hereinafter referred to as resource used amount information).

As an example, the resource used amount information may be information relating to a CPU utilization, a used amount of a memory, a used amount of a disk, network communications traffic, or the like. The used amount of the disk may be information relating to an input or output to/from a disk. In addition, the resource used amount information may include, for example, information relating to the number of lost packets in a network, a round trip time (RTT), or the like.

In addition, the analysis server 2 collects, from the information processing system 1, information (response time information) relating to a response time of the information processing system 1 to a request. As an example, the analysis server 2 may capture a communication packet that is relayed by the switch 4, and may obtain response time information according to the communication packet.

In this case, the analysis server 2 analyzes the collected communication packet, and reconfigures a request and a response of a protocol message. The analysis server 2 may calculate a response time from times of the reconfigured request and response.

The analysis server 2 analyzes (evaluates) the performance of the information processing system 1 by using the collected resource used amount information and response time information. As a result of the performance analysis, the quality of a service provided by the information processing system 1 is obtained. In the embodiment, it is assumed that the quality of the service is a response time to a request to the information processing system 1.

In the embodiment, it is assumed that the analysis server 2 determines that the quality of the service has deteriorated beyond a specified limit when the response time to the request exceeds a prescribed threshold. In this case, the analysis server 2 may output an alert. The alert may be recognized by an administrator that administrates the information processing system 1.

As an example, in a case in which an administrator that administrates the information processing system 1 operates the analysis server 2, a screen indicating an alert may be displayed on a display of the analysis server 2. Alternatively, the analysis server 2 may transmit information indicating an alert to a terminal operated by the administrator. Consequently, the administrator recognizes the need to take countermeasures against the information processing system 1.

Accordingly, it is preferable that a threshold to be compared with a response time be appropriately specified. Assume here a case in which the threshold is manually specified. The manually specified threshold may be an inappropriate value. In addition, it is conceivable that the analysis server 2 stores the resource used amount information, and that the analysis server 2 specifies the threshold by analyzing the stored resource used amount information.

As an example, when analysis is performed according to resource used amount information that has been stored while the information processing system 1 is normally operating, resource used amount information in a case in which the information processing system 1 is not normally operating is not considered, and therefore an appropriate threshold is not specified.

A relationship between a used amount of a resource and a response time does not always change with a specified trend, and when the used amount of the resource reaches a prescribed boundary value, the response time may greatly increase even when a rate of an increase in the used amount of the resource is small.

Therefore, it is difficult for the analysis server 2 to appropriately specify the threshold. When the threshold is not appropriately specified, it is difficult for the analysis server 2 to determine whether the quality of a service provided by the information processing system has deteriorated beyond a specified limit. Accordingly, the analysis server 2 specifies the boundary value above, and defines the threshold on the basis of the boundary value.

The information processing system 1 includes a plurality of resources (for example, a CPU, a memory, a disk, and the like). The analysis server 2 specifies a boundary value that defines the threshold for each of the plurality of resources on the basis of a used amount of a corresponding resource and a response time. The used amount of the resource may be, for example, a value indicating the sum of values for a plurality of servers that implement prescribed functions.

### <Example of Analysis Server 2>

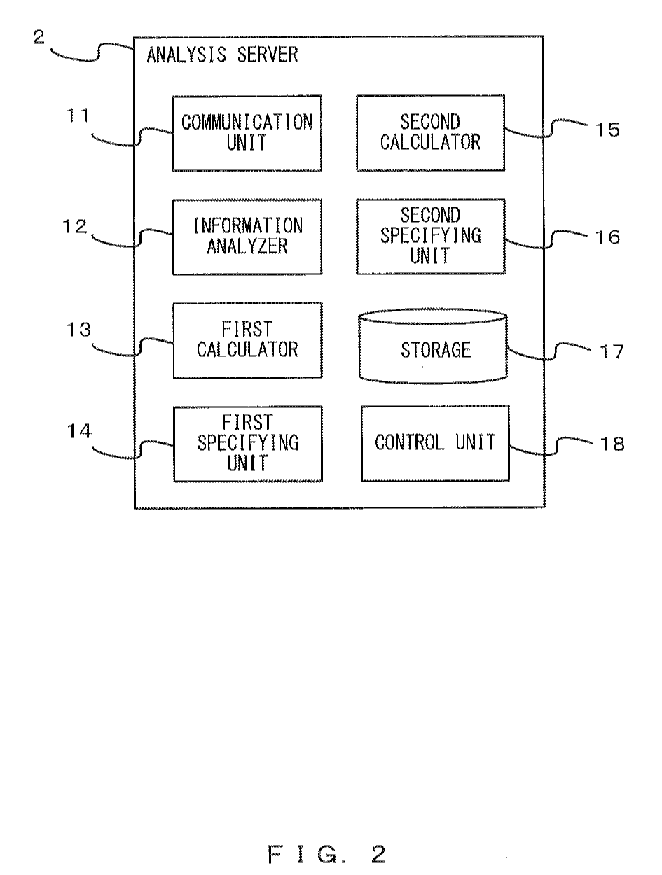

FIG. 2 illustrates an example of the analysis server 2. The analysis server 2 includes a communication unit 11, an information analyzer 12, a first calculator 13, a first specifying unit 14, a second calculator 15, a second specifying unit 16, a storage 17, and a control unit 18.

The communication unit 11 performs communication with the information processing system 1, and collects resource used amount information and response time information at specified time intervals. The information analyzer 12 analyzes the collected resource used amount information and response time information.

The communication unit 11 may collect information other than the response time information and the resource used amount information. As described above, the response time information is information relating to a response time to a request to the information processing system 1. The resource used amount information is information relating to a resource in the information processing system 1 that is used according to the request.

The communication unit 11 collects response time information and resource used amount information for each resource at specified time intervals. The resource used amount information collected by the communication unit 11 may be statistical information. As an example, the resource used amount information may be a mean value, a median, a maximum value, a minimum value, or the like of resource used amounts at specified summation intervals (for example, at every 10 seconds).

The communication unit 11 may collect, for example, a log from the WEB server 3A on the information processing system 1. In this case, information relating to a response time to each service request is obtained on the basis of the log collected by the communication unit 11.

The analysis server 2 may collect resource used amount information and response time information during a prescribed period (for example, for one day), and may perform, for example, a process for calculating a boundary value after the prescribed period has passed. In the embodiment, assume that the analysis server 2 calculates a boundary value that defines a threshold on the basis of previously collected data. Therefore, in the embodiment, the boundary value is not calculated in real time.

The boundary value that defines the threshold is calculated on the basis of the resource used amount information and the response time information. Therefore, it is preferable that the number of samples of the resource used amount information and the response time information be large.

As an example, the number of samples is a value obtained by dividing a period (a collection period) during which the resource used amount information and the response time information are collected by a time interval (a summation time interval) at which the data is summed. Accordingly, as the collection period increases, and as the summation time interval decreases, the number of obtained samples increases.

When the number of samples is small, resource used amount information and response time information only when the information processing system 1 is normally operating may be collected, for example.

When a boundary value is calculated on the basis of the resource used amount information and the response time information only when the information processing system 1 is normally operating, the boundary value may be an inappropriate value. When a boundary value that defines a threshold is an inappropriate value, the threshold is also an inappropriate value.

Accordingly, it is preferable that data in both a case in which the information processing system 1 is normally operating and a case in which the information processing system 1 is not normally operating be collected.

It is also preferable that a value of a used amount of a resource have a wide range of distribution. Assume, for example, that the resource used amount information (a CPU utilization) that is collected by the communication unit 11 is “0% to 40%”. Even in this case, when a period of time during which a response time greatly decreases is included within a range of “0% to 40%”, an appropriate boundary value is calculated.

When the period of time during which the response time greatly decreases is not included in response times included in the data collected by the communication unit 11, the analysis server 2 may output a result indicating this fact.

A specific example of the resource used amount information is described. The description below will be made under the assumption that a used amount of a resource is a CPU utilization, but the used amount of the resource is not limited to the CPU utilization. As an example, the used amount of the resource may be a used amount of a memory.

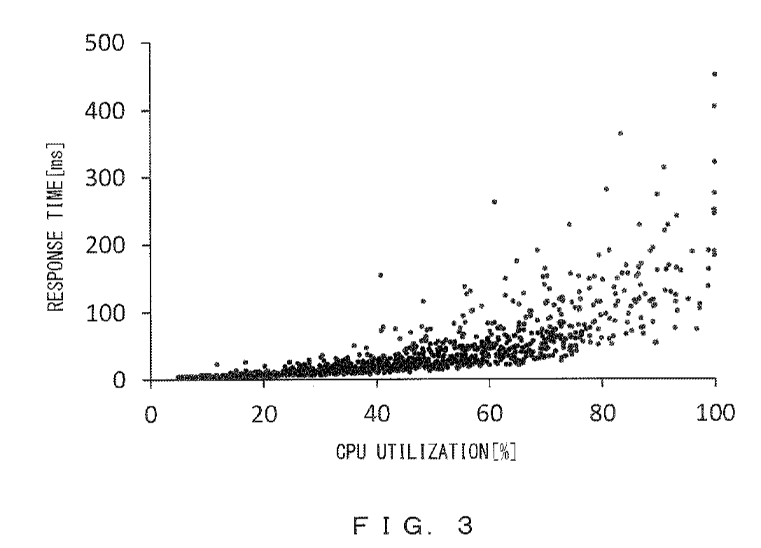

FIG. 3 is an example of a scatter diagram illustrating a relationship between a CPU utilization and a response time that is generated by the information analyzer 12 on the basis of the resource used amount information and the response time information that have been collected by the communication unit 11. Each plot in the scatter diagram indicates a response time of the information processing system 1 according to a CPU utilization of the server system 3.

The communication unit 11 collects resource used amount information and response time information at specified time intervals (for example, for every ten seconds). The information analyzer 12 analyzes a used amount of a resource and a response time on the basis of the collected resource used amount information and response time information.

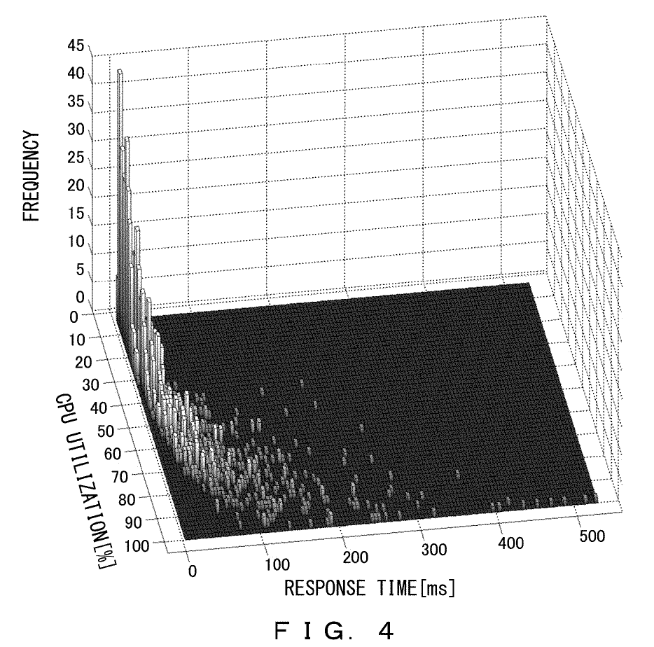

As illustrated in the example of FIG. 3, respective plots in the case of a low CPU utilization are converged within a short response time. In contrast, respective plots in the case of a high CPU utilization are widely scattered. FIG. 4 illustrates an example of a three-dimensional histogram based on the scatter diagram of FIG. 3.

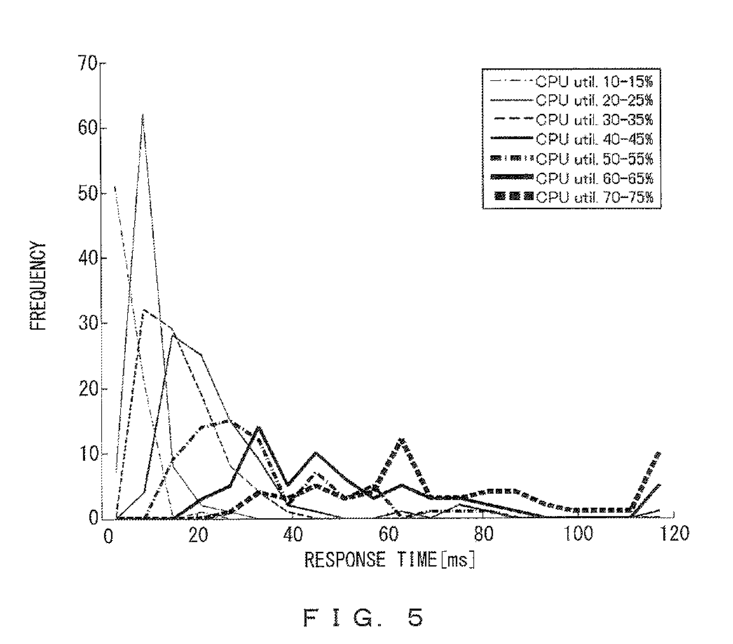

FIG. 5 illustrates an example of a two-dimensional histogram of a response time in a case in which a CPU utilization is divided into prescribed sections. The example of FIG. 5 illustrates a two-dimensional histogram illustrating a CPU utilization in each section in a case in which a CPU utilization in the three-dimensional histogram of FIG. 4 is divided into prescribed sections. A horizontal axis indicates a response time, and a vertical axis indicates a frequency.

As illustrated in the example of FIG. 5, a two-dimensional histogram in the case of a low CPU utilization is a distribution close to an ex-Gaussian distribution. In contrast, a two-dimensional histogram in the case of a high CPU utilization is an irregular distribution that does not conform to the ex-Gaussian distribution. The ex-Gaussian distribution is an example of a prescribed distribution.

The ex-Gaussian distribution is a distribution obtained by convoluting a Gaussian distribution (a normal distribution) with an exponential distribution. The convoluting is also convolution integral. The ex-Gaussian distribution is a distribution determined by three parameters (μ,σ,τ).

In the three parameters (μ,σ,τ), the parameters (μ,σ) are parameters that determine the Gaussian distribution. The parameter (τ) is a parameter that determines the exponential distribution. If the two-dimensional histogram above is close to the ex-Gaussian distribution, it indicates that a relationship between a used amount of a resource and a response time follows a specified trend.

If the two-dimensional histogram is an irregular distribution that does not conform to the ex-Gaussian distribution, it indicates that the relationship between the used amount of the resource and the response time does not follow a specified trend. Stated another way, when the two-dimensional histogram does not conform to the ex-Gaussian distribution, the relationship between the used amount of the resource and the response time is an irregular relationship. In this case, a threshold that is obtained on the basis of the used amount of the resource is highly likely to be an inappropriate threshold.

Accordingly, the first calculator 13 fits a prescribed distribution to a histogram of a response time in each section obtained by dividing the used amount of the resource (the CPU utilization) at every prescribed spacing for a pair of the response time and the used amount of the resource.

The first calculator 13 fits the histogram to the ex-Gaussian distribution, and calculates a degree of fitting each other in each of the sections. The first calculator 13 is an example of a calculator.

In the embodiment, the first calculator 13 fits a histogram indicating a frequency of a response time in each of the sections obtained by dividing the CPU utilization at every prescribed spacing to the ex-Gaussian distribution by using the maximum likelihood method, and the first calculator calculates a degree of fitting the histogram to the ex-Gaussian distribution in each of the sections.

The first calculator 13 obtains, for example, a minimum observed value and a maximum observed value of the CPU utilization, and divides a range between the minimum observed value to the maximum observed value into a specified number (n) of sections. In the embodiment, the first calculator 13 divides the CPU utilization into twenty sections. The number of divided sections is not limit to 20.

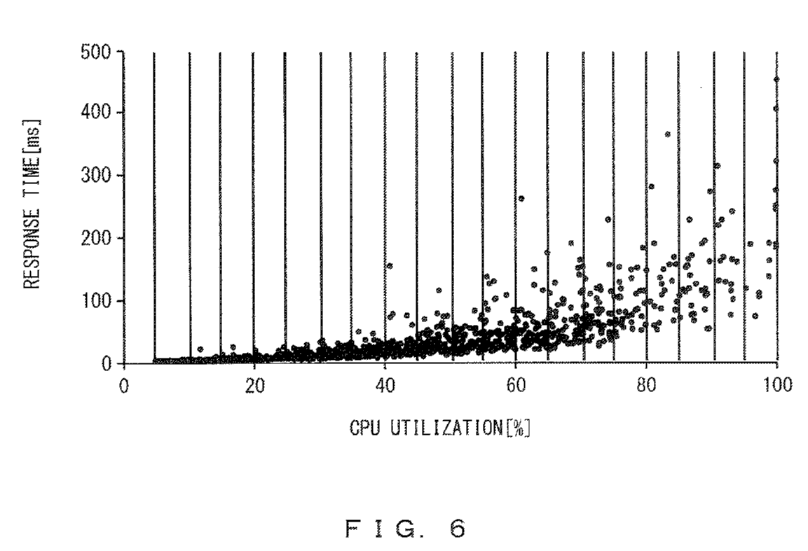

It is preferable that the number of sections be greater than or equal to a prescribed number (for example, 15) in order to specify an appropriate boundary value. FIG. 6 illustrates an example in which the CPU utilization (0% to 100%) in the scatter diagram of FIG. 3 is divided into twenty sections. In this case, the width of one section is 5%.

The first calculator 13 generates a histogram indicating a frequency of a response time that corresponds to a CPU utilization in each of the sections. The first calculator 13 also fits the histogram indicating the frequency of the response time to the ex-Gaussian distribution by using, for example, the maximum likelihood method.

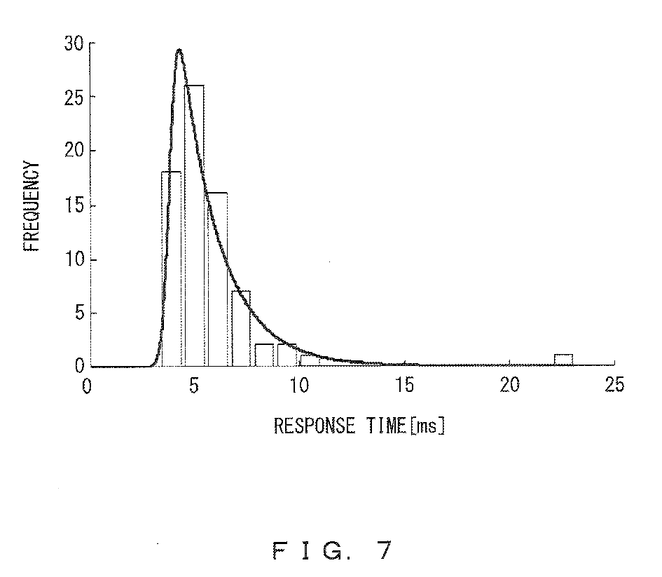

FIG. 7 illustrates an example in which an ex-Gaussian distribution is fitted to a histogram (in a section of a CPU utilization of 20% to 25%) that indicates a frequency of a response time that corresponds to a CPU utilization. A curve that is illustrated with a solid line in the example of FIG. 7 indicates a curve obtained by performing the fitting above. In this case, respective values of a set of variables that define the ex-Gaussian distribution are μ=3.81, σ=0.31, and τ=0.81.

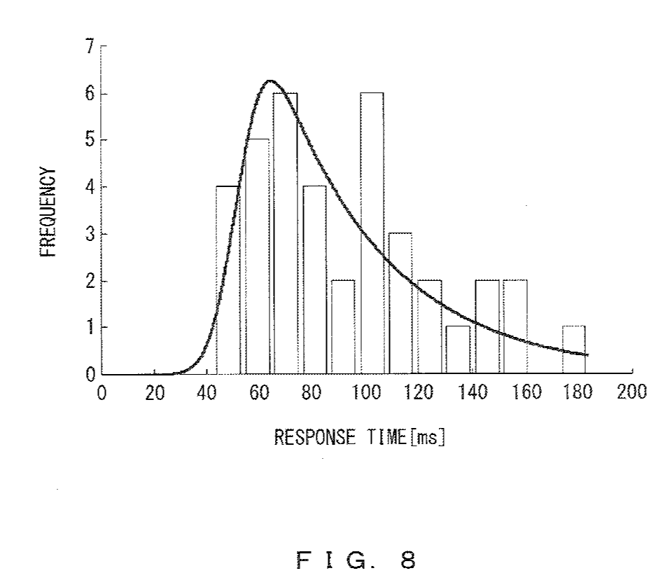

FIG. 8 illustrates an example in which an ex-Gaussian distribution is fitted to a histogram (in a section of a CPU utilization of 75% to 80%) that indicates a frequency of a response time that corresponds to a CPU utilization. A curve that is illustrated with a solid line in the example of FIG. 8 indicates a curve obtained by performing the fitting above. In this case, respective values of a set of variables that define the ex-Gaussian distribution are μ=52.02, σ=8.48, and τ=41.17.

The first calculator 13 tests a probability of a fitting result. The first calculator 13 calculates the probability of the fitting result by using, for example, the one-sample Kolmogorov-Smirnov test (hereinafter referred to as the KS test). The probability of the fitting result may be calculated by using a scheme other than the KS test.

The first calculator 13 performs the KS test by using a critical section of about 0.05. Namely, an error up to 5% of a test result is allowed. Assume that a degree of freedom in the KS test is a value obtained by subtracting 2 from the number of data samples (the number of pieces of data of a pair of a resource usage and a response time) that are included in a current section.

The first specifying unit 14 obtains a result of the KS test from the first calculator 13, and specifies a boundary value that defines a threshold of a used amount of a resource on the basis of a change in a degree of fitting the histogram to the ex-Gaussian distribution. The first specifying unit 14 is an example of a specifying unit.

The first specifying unit 14 specifies a boundary value used to specify the threshold on the basis of a used amount of a resource at a boundary between a section in which the degree of fitting the histogram to the ex-Gaussian distribution is higher than a prescribed reference and a section in which the degree is lower than the prescribed reference. The prescribed reference may be set to any arbitrary value that defines the threshold.

As an example, in a case in which fitting in a certain section is rejected as a test result, the first specifying unit 14 specifies and outputs a value at a boundary between the certain section and the preceding section as a boundary value. This boundary value is a used amount of a resource whereby the quality of a service provided by the information processing system 1 starts to be affected.

The second calculator 15 calculates a line indicating a trend of a change in a set of variables in each section that define a prescribed distribution. The second calculator 15 calculates an orthogonal regression line of the set of variables as the line indicating the trend of a change in the set of variables, for example, by performing principal component analysis on the set of variables. The orthogonal regression line may be calculated by using a scheme other than principal component analysis.

The second calculator 15 obtains an ex-Gaussian distribution that the first calculator 13 has used for fitting in each of the sections. The second calculator 15 performs principal component analysis on a change in three parameter values (μ,σ,τ) of each of the ex-Gaussian distributions, and obtains a first component. A line indicated by the first component is an orthogonal regression line in a three-dimensional space of the parameter values (μ,σ,τ).

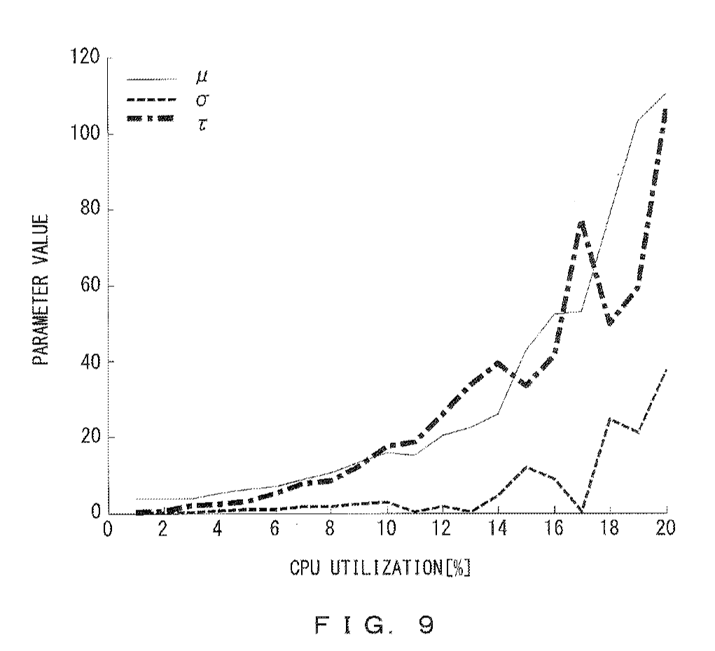

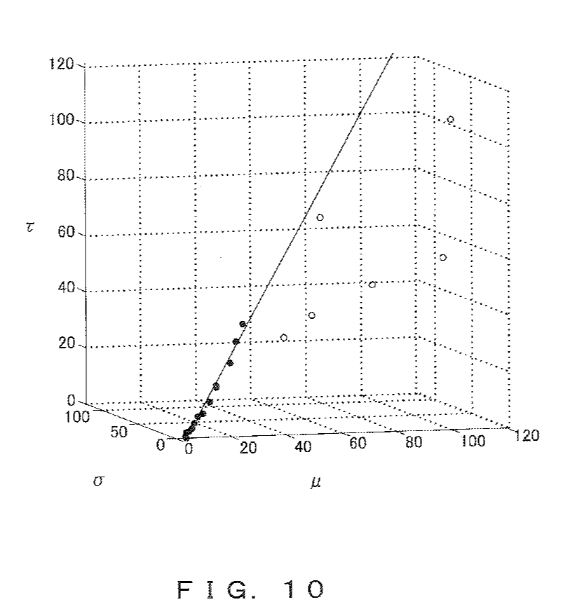

FIG. 9 illustrates a change in the parameter values (μ,σ,τ) in respective sections of a CPU utilization. FIG. 10 is a diagram in which the parameter values (μ,σ,τ) are approximated to the orthogonal regression line in the three-dimensional space.

A line in the example of FIG. 10 is an orthogonal regression line obtained as a result of performing principal component analysis on respective parameters in the 1st section to the (n−1)th section (r₁, r₂, . . . , rₙ₋₁). In FIG. 10, black points indicate parameters in sections r₁, r₂, . . . , and rₙ₋₁, and while points indicate parameters obtained in section rₙ and sections that follow.

The second specifying unit 16 specifies a CPU utilization used as a boundary value on the basis of a distance between the orthogonal regression line and a set of variables in a prescribed section. The second specifying unit 16 specifies a used amount of a resource that is used as a boundary value, for example, when the distance between the orthogonal regression line and the set of variables in the prescribed section is greater than or equal to a prescribed value.

The second specifying unit 16 tests, for example, whether three parameter values in a certain section are located along the orthogonal regression line (an outlier test), and when the three parameter values significantly (statistically significantly) deviate from the orthogonal regression line, the second specifying unit 16 specifies the certain section as the boundary value.

Assume, for example, that a section to be tested is rₙ. The second specifying unit 16 calculates respective distances (d₁, d₂, . . . , dₙ₋₁) between tree parameters (a point in a three-dimensional space) in sections 1 to n−1 (r₁, r₂, . . . , rₙ₋₁) and the orthogonal regression line.

The second specifying unit 16 calculates a distance dₙ between three parameters (a point in a three-dimensional space) in section rₙ to be tested and an orthogonal regression line in the sections (r₁, r₂, . . . , rₙ₋₁). The second specifying unit 16 performs the Smirnov-Grubbs test to determine whether dₙ is an outlier from among d₁, d₂, . . . , and dₙ. A test to determine whether dₙ is an outlier is not limited to the Smirnov-Grubbs test.

As a result of performing the Smirnov-Grubbs test, when the second specifying unit 16 determines that a parameter in a specified section is an outlier, the parameter is considered to significantly deviate from the line.

Stated another way, a response time distribution in section rₙ to be tested does not follow a trend of a change in a response time in the previous sections, and therefore the second specifying unit 16 specifies a value at a boundary between the section to be tested and the previous section as a boundary value.

In the Smirnov-Grubbs test, when dₙ satisfies the expression below, it is determined that dₙ is an outlier. d_{A} is a mean of distances (d₁, d₂, . . . , dₙ), and σ is a standard deviation of the statistically distances (d₁, d₂, . . . , dₙ). α is a needed level of significance, and t is the ((α/n)×100)-th percentile value of distribution t of a degree n−2 of freedom.

$${d}_{n} \geq {d}_{A} + σ \frac{( n - 1 ) t}{\sqrt{n ( n - 2 ) + n {t}^{2}}}$$

It is preferable that the second specifying unit 16 perform a process for specifying a boundary value in a prescribed number (for example, 5) or more of sections. When n<5, the number of samples of a distance between three parameters (a point in a three-dimensional space) and the orthogonal regression line is small, and the orthogonal regression lines is obtained on the basis of a small number of points. Therefore, a distribution of the distance is biased. Thus, it is difficult to appropriately perform the outlier test.

The second specifying unit 16 does not specify a point that is an outlier in some cases. In these cases, the second specifying unit 16 outputs a result indicating that a boundary value has not been detected.

When the boundary value has not been detected, there is a probability that the collected resource used amount information and response time information have not been affected to such an extent that the quality of a service provided by the information processing system 1 is greatly reduced. When the boundary value has not been detected, the boundary value may fail to be detected due to a small number of samples.

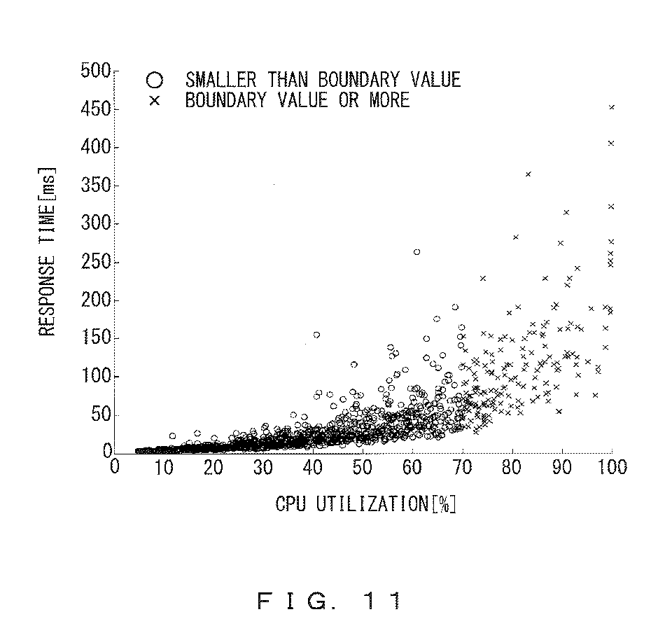

FIG. 11 is a scatter diagram illustrating a relationship between a CPU utilization and a response time of the entirety of a system after the detection of a boundary value. The example of FIG. 11 illustrates a case in which a CPU utilization of 70% has been extracted as a boundary value that affects a response time of the system. In FIG. 11, a circle indicates a response time that is smaller than the boundary value. x in FIG. 11 indicates a response time that is greater than or equal to the boundary value.

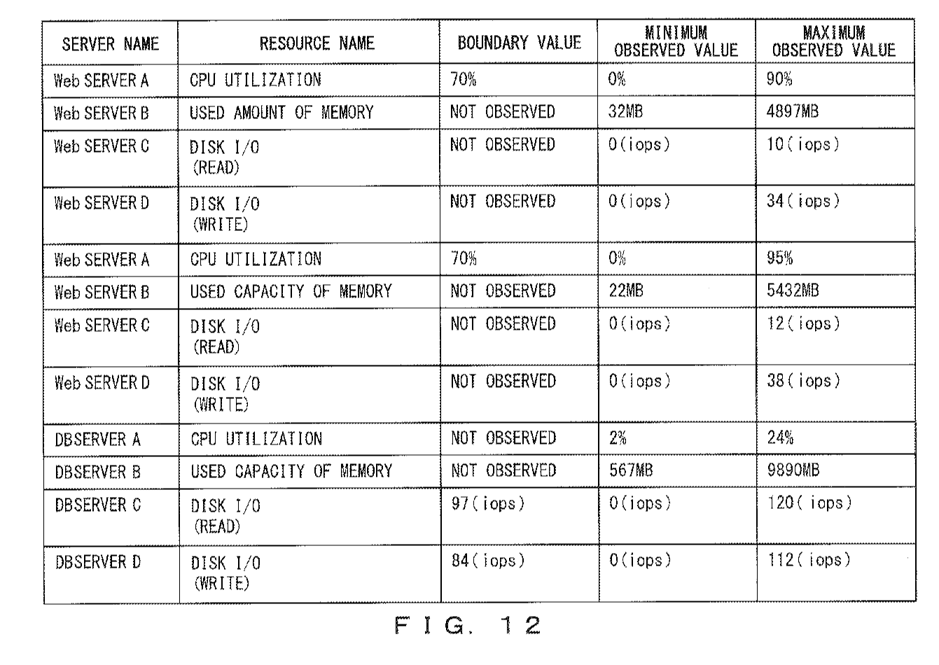

FIG. 12 illustrates an example of an output result. As illustrated in the example of FIG. 12, the analysis server 2 outputs a value specified as a boundary value or outputs a result indicating that a boundary value has not been detected, for each server (each resource).

The control unit 18 performs various processes of the analysis server 2. The control unit 18 specifies a threshold on the basis of the boundary value specified by the first specifying unit 14 or the second specifying unit 16. The control unit 18 may specify, for example, the same value of the boundary value as the threshold, or may specify a value different from the boundary value (for example, 95% of the boundary value) as the threshold.

Accordingly, the analysis server 2 in the embodiment can appropriately calculate a boundary value of a used amount of a resource that is a reference to determine whether the quality of a service provided by the information processing system 1 has deteriorated. Consequently, an appropriate threshold is specified, and a threshold is not manually specified. This results in a decrease in tasks.

In addition, an alert is output according to the appropriate threshold, and therefore time and effort for taking countermeasures against a deterioration in the quality of a system are minimized, and the probability of overlooking a deterioration in the quality of the service is reduced. Thus, the quality of the service can be kept high.

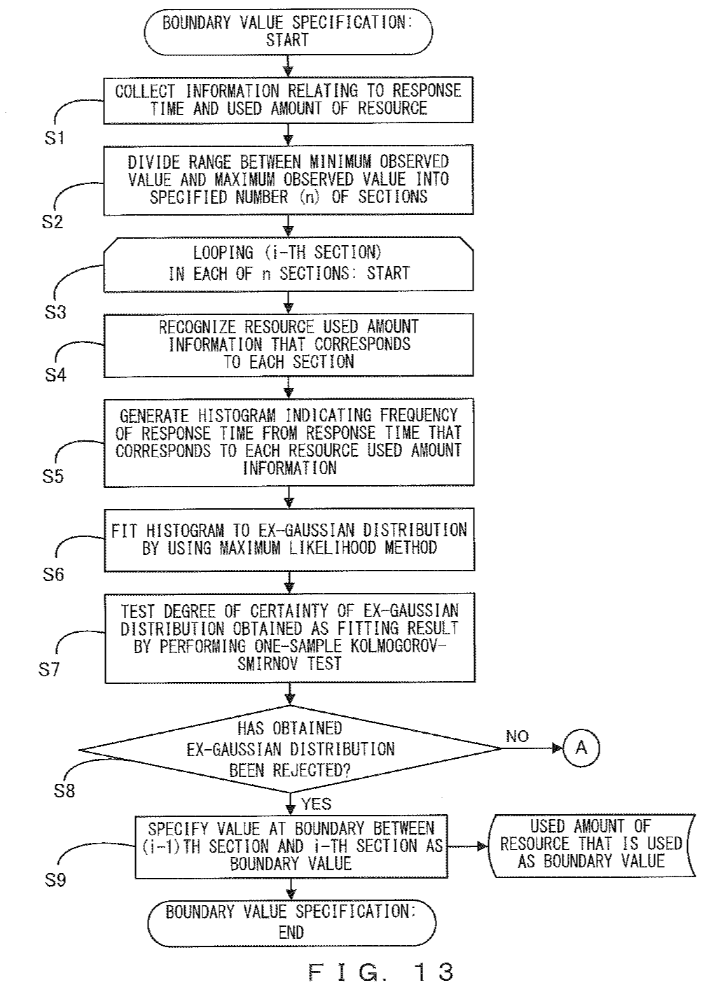

FIGS. 13 to 15 are flowcharts illustrating an example of a flow of processing according to the embodiment. The communication unit 11 obtains response time information and resource used amount information at specified time intervals (step S1). The first calculator 13 divides a range from a minimum observed value to a maximum observed value in the resource used amount information into a specified number of sections (n sections: n is an integer greater than or equal to 2) (step S2). As an example, the first calculator 13 divides the range from the minimum observed value to the maximum observed value into 20 sections.

The control unit 18 starts looping in each of the n sections (step S3). Looping is terminated in step S21. The processing may be terminated in the middle of looping. Assume that a section being processed is the i-th section (i is a natural number). i starts from “1”.

The first calculator 13 recognizes resource used amount information that corresponds to each of the sections (step S4), and generates a histogram indicating a frequency of a response time from a response time that corresponds to the resource used amount information in each of the sections (step S5).

The first calculator 13 fits the generated histogram to an ex-Gaussian distribution by using the maximum likelihood method (step S6). The first calculator 13 tests a probability of the ex-Gaussian distribution obtained as a fitting result, by using the KS test (step S7). The first specifying unit 14 obtains a test result, and determines whether fitting to the ex-Gaussian distribution has been rejected (step S8).

When it is determined that fitting has been rejected (YES in step S8), the first specifying unit 14 specifies a value (for example, a CPU utilization) at a boundary between the (i−1)th section and the i-th section as a boundary value. As an example, in a case in which a boundary value of the CPU utilization is 70%, when the CPU utilization exceeds 70%, the quality of a service provided by the information processing system 1 greatly deteriorates.

The boundary value specified by the first specifying unit 14 is a value that defines a threshold. When the determination result in step S8 is YES, the first specifying unit 14 outputs the specified boundary value (step S9). The control unit 18 specifies a threshold according to the output boundary value.

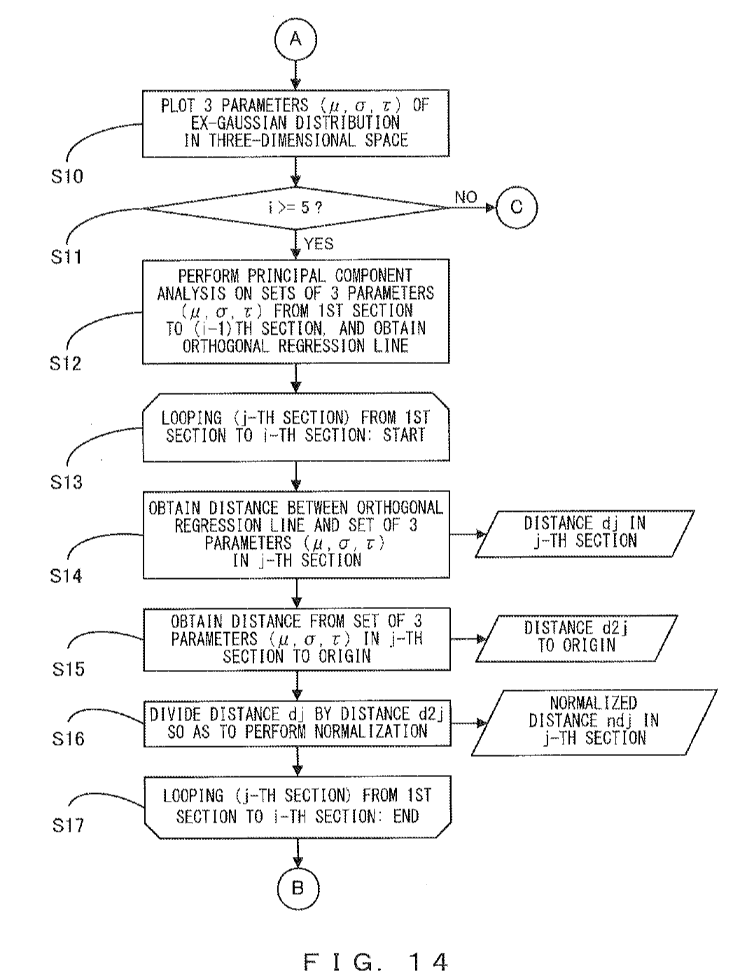

When it is not determined that fitting has been rejected (NO in step S8), the processing moves on to “A”. The processing after “A” is described with reference to the example of FIG. 14. The second calculator 15 plots three parameters (μ,σ,τ) that define an ex-Gaussian distribution in a three-dimensional space (step S10).

When i is 5 or more (YES in step S11), the second calculator 15 calculates an orthogonal regression line from a first component obtained by performing principal component analysis on sets of variables (μ,σ,τ) from the first section to the (i−1)th section (step S12).

The control unit 18 starts looping in the first section to the i-th section (step S13). Looping is terminated in step S17. Assume that a section being processed is the j-th section (j is a natural number).

The second specifying unit 16 obtains a distance (dᵢ) between the orthogonal regression line obtained in step S12 and a set of variables (μ,σ,τ) in the j-th section (step S14). The second specifying unit 16 obtains a distance (d2ᵢ) from the set of variables (μ,σ,τ) in the j-th section to the origin (step S15). The second specifying unit 16 performs normalization by dividing distance dᵢ by distance d2ᵢ (step S16).

As described above, the orthogonal regression line is a straight line that is obtained by performing principal component analysis on plural sets of variables (μ,σ,τ). The respective values of the plural sets of variables (μ,σ,τ) increase as a value of j increases.

As the respective values of the plural sets of variables (μ,σ,τ) increase, an influence on a value of the orthogonal regression line also increases. By performing normalization in step S16, the influence on the value of the orthogonal regression line is reduced.

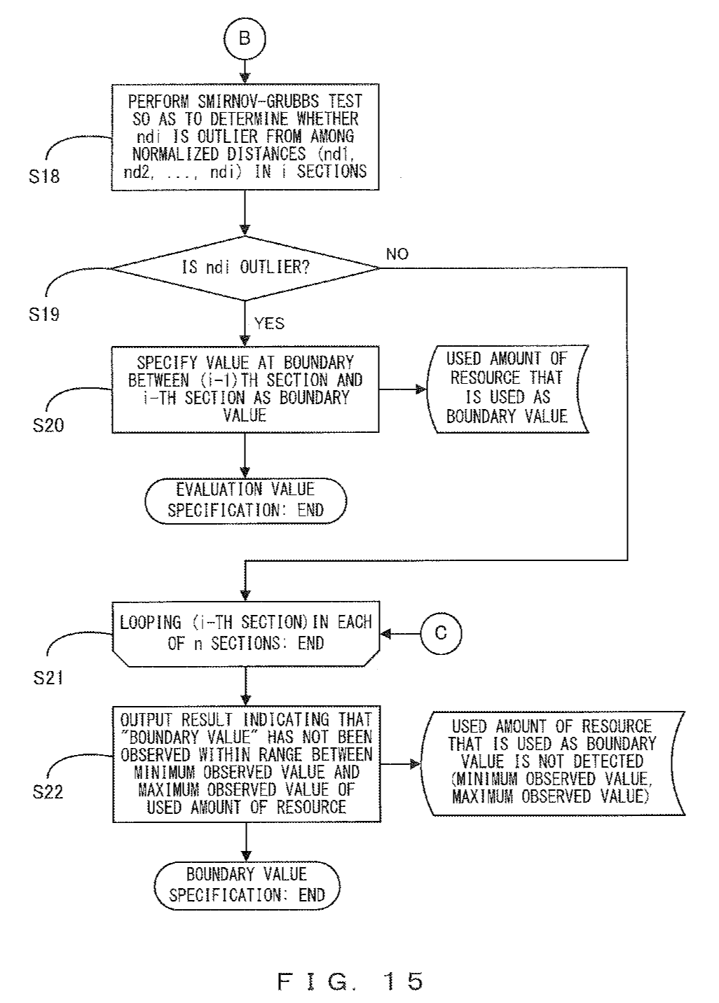

The control unit 18 terminates looping (the j-th section) from the first section to the i-th (step S17). The processing moves on to “B”. The processing after “B” is described with reference to the example of FIG. 15.

The second specifying unit 16 tests whether nd₁ is an outlier from among normalized distances (nd₁, nd₂, . . . , ndᵢ) in i sections by performing the Smirnov-Grubbs test (step S18).

The second specifying unit 16 may perform the Smirnov-Grubbs test by using the above distance dj that has not been normalized. In this case, the processes of steps S15 and S16 are not performed.

The second specifying unit 16 determines whether nd₁ is an outlier (step S19). When nd₁ is an outlier (YES in step S19), the second specifying unit 16 specifies and outputs a value at a boundary between the (i−1)th section and the i-th section as a boundary value (step S20).

When the second specifying unit 16 determines that nd1 is not an outlier (NO in step S19), the control unit 18 terminates looping (the i-th section) in each of the n sections (step S21). In addition, the second specifying unit 16 outputs a report indicating that no “boundary value” has been observed in a range from a minimum observed value to a maximum observed value of the used amount of the resource calculated in step S1 (step S22).

### <Example of Hardware Configuration of Boundary Value Specifying Apparatus>

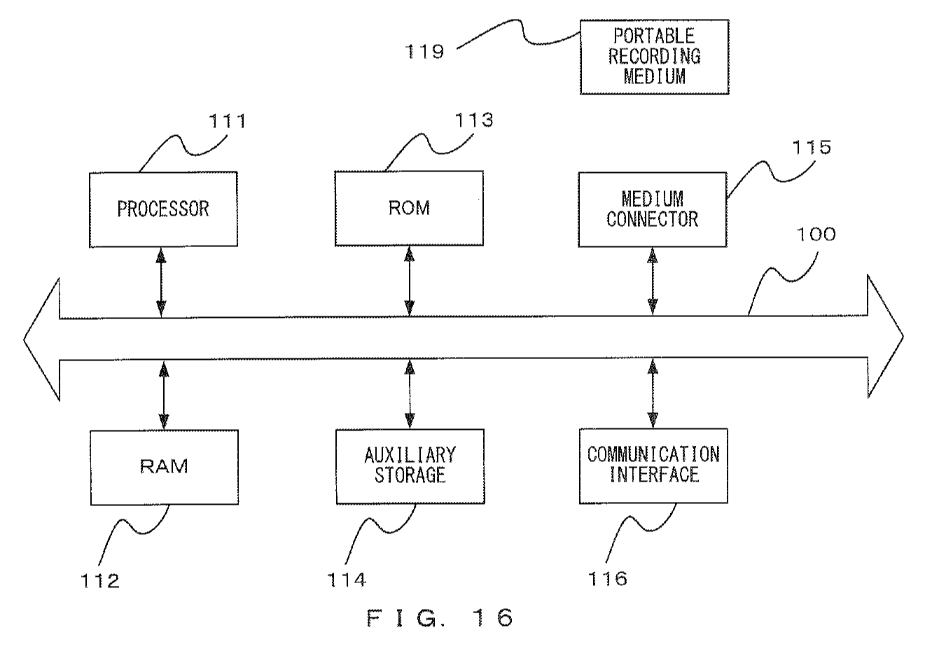

An example of a hardware configuration of the analysis server 2 is described next. FIG. 16 illustrates an example of the hardware configuration of the analysis server 2. As illustrated in the example of FIG. 16, a processor 111, a random access memory (RAM) 112, and a read only memory (ROM) 113 are connected to a bus 100. In addition, an auxiliary storage 114, a medium connector 115, and a communication interface 116 are connected to the bus 100.

The processor 111 executes a program expanded in the RAM 112. As the program to be executed, a boundary value specifying program for performing the processing according to the embodiment may be employed.

The ROM 113 is a non-volatile storage that stores the program expanded in the RAM 112. The auxiliary storage 114 is a storage that stores various types of information, and a hard disk drive, a semiconductor memory, or the like may be employed, for example, as the auxiliary storage 114. The medium connector 115 is provided so as to be connectable to a portable recording medium 118.

As the portable recording medium 118, a portable memory, an optical disk (such as a compact disc (CD) or a digital versatile disc (DVD)), a semiconductor memory, or the like may be employed. The boundary value specifying program for performing the processing according to the embodiment may be recorded in the portable recording medium 118.

The storage 17 may be implemented by the RAM 112, the auxiliary storage 114, or the like. The communication unit 11 may be implemented by the communication interface 116. The information analyzer 12, the first calculator 13, the first specifying unit 14, the second calculator 15, the second specifying unit 16, and the control unit 18 may be implemented by the processor 111 executing a given boundary value specifying program.

All of the RAM 112, the ROM 113, the auxiliary storage 114, and the portable recording medium 118 are examples of a computer-readable tangible storage medium. These tangible storage media are not transitory media such as signal carriers.

### <Others>

According to the embodiment above, an appropriate threshold that is compared with a used amount of a system can be obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recoding medium having stored therein a boundary value specifying program that causes a computer to execute a process comprising:
collecting information relating to a response time to a service request to an information processing system and information relating to a used amount of a resource in the information processing system at specified time intervals, the used amount of the resource being used for the service request;
fitting a prescribed distribution to a histogram of a response time in each of sections for a pair of the response time and the used amount of the resource, and calculating a degree of fitting of the histogram and the prescribed distribution in each of the sections, each of the sections being obtained by dividing the used amount of the resource at prescribed intervals; and
specifying a boundary value that defines a threshold of the used amount of the resource in accordance with a change in the degree of fitting.

2. The non-transitory computer-readable recoding medium according to claim 1, wherein
the boundary value is specified in accordance with a section in which the degree of fitting is higher than a prescribed reference and a section in which the degree of fitting is lower than the prescribed reference.

3. The non-transitory computer-readable recoding medium according to claim 1, wherein
a line indicating a trend of a change in a set of variables in each of the sections is calculated, the set of variables defining the prescribed distribution, and
the boundary value is specified in accordance with a distance between the calculated line indicating the trend of the change and the set of variables in a prescribed section.

4. The non-transitory computer-readable recoding medium according to claim 3, wherein
an orthogonal regression line of the set of variables is calculated as the line by performing principal component analysis on the set of variables, and
the boundary value is specified in accordance with the used amount of the resource in the prescribed section, when a distance between the orthogonal regression line and the set of variables in the prescribed section.

5. The non-transitory computer-readable recoding medium according to claim 1, wherein
a histogram indicating a frequency of the response time in each of the sections is fitted to an ex-Gaussian distribution for the pair of the response time and the used amount of the resource by using a maximum likelihood method, and the degree of fitting is calculated in each of the sections, each of the sections being obtained by dividing the used amount of the resource at prescribed intervals.

6. The non-transitory computer-readable recoding medium according to claim 5, wherein
a probability of the fitting in a case in which the histogram is fitted to the ex-Gaussian distribution is calculated by using a one-sample Kolmogorov-Smirnov test.

7. The non-transitory computer-readable recoding medium according to claim 4, wherein
the distance between the orthogonal regression line and the set of variables in the prescribed section is calculated, and whether the calculated distance is an outlier is determined by using a Smirnov-Grubbs test.

8. The non-transitory computer-readable recoding medium according to claim 4, wherein
when no sections are present in which the degree of fitting is lower than a prescribed reference and no sections are present in which the distance between the orthogonal regression line and the set of variables in the prescribed section is greater than or equal to the prescribed value, a result indicating that the boundary value is not observed is output.

9. A boundary value specifying method executed by a processor, the boundary value specifying method comprising:
collecting information relating to a response time to a service request to an information processing system and information relating to a used amount of a resource in the information processing system at specified time intervals, the used amount of the resource being used for the service request;
fitting a prescribed distribution to a histogram of a response time in each of sections for a pair of the response time and the used amount of the resource, and calculating a degree of fitting of the histogram and the prescribed distribution in each of the sections, each of the sections being obtained by dividing the used amount of the resource at prescribed intervals; and
specifying a boundary value that defines a threshold of the used amount of the resource in accordance with a change in the degree of fitting.

10. A boundary value specifying apparatus comprising:
a processor configured to execute a process including:
collecting information relating to a response time to a service request to an information processing system and information relating to a used amount of a resource in the information processing system at specified time intervals, the used amount of the resource being used for the service request;
fitting a prescribed distribution to a histogram of a response time in each of sections for a pair of the response time and the used amount of the resource, and calculating a degree of fitting of the histogram and the prescribed distribution in each of the sections, each of the sections being obtained by dividing the used amount of the resource at prescribed intervals; and
specifying a boundary value that defines a threshold of the used amount of the resource in accordance with a change in the degree of fitting.
